(19) United States
(12) Patent Application Publication
(10) Pub. No.: US 2023/0378618 A1
(43) Pub. Date: Nov. 23, 2023

(54) Method for Contacting Components in Electric Systems in a Bonded Manner, Energy Storage Unit, and Use of the Energy of an Energy Storage Unit

(71) Applicant: Bayerische Motoren Werke Aktiengesellschaft, Muenchen (DE)

(72) Inventor: Robert ALIG, Germering (DE)

(21) Appl. No.: 18/030,923

(22) PCT Filed: Nov. 4, 2021
(86) PCT No.: PCT/EP2021/080587

§ 371 Date: Apr. 7, 2023

(30) Foreign Application Priority Data
Nov. 30, 2020 (DE) 10 2020 131 622.4

(51) Int. Cl. H01M 50/516; H01M 50/509; H01M 50/521

(52) U.S. Cl. CPC H01M 50/516; H01M 50/509; H01M 50/521

(57) ABSTRACT

A method for contacting components in electric systems in a bonded manner, including providing a plurality of components having contact elements for making electric contact, contacting the components via the contact elements in order to generate a current path, and generating a flow of current in the current path in order to bond the contact elements via the thermal energy produced in the current path.

### FIELD

The present invention relates to a method for contacting components in electric systems in a bonded manner, an energy storage unit, and use of the energy of an energy storage unit.

### BACKGROUND AND SUMMARY

It is generally known that, for example, two electric conductors can be screwed to one another in order to be contacted. In order to reduce the contact resistance at the contact point, bonding methods, for example soldering, are preferred for establishing contact or for connection. For high-voltage stores, as are used for example in partly or fully electrified motor vehicles, this means that the cables or module connectors used to connect the individual battery modules are oversized in order to keep the contact resistance at their contact points as low as possible and in order to limit the development of heat. To bond all contact points, for example by means of soldering, however, series production has proven to be complex and thus costly. For example, one problem is the accessibility to the solder or contact points.

It is therefore an object of the present invention to specify a method for contacting components in electric systems in a bonded manner, an energy storage unit and a use of the energy of an energy storage unit, wherein the known methods or approaches for making contact in a bonded manner are to be optimized and simplified.

The object is achieved by a method according to the present disclosure, by a high-voltage store according to the present disclosure and by a use according to the present disclosure. Further advantages and features can be found in the description and the appended figures.

According to the invention a method for contacting components in electric/electronic systems in a bonded manner comprises the steps of:
providing a plurality of components, wherein the components have contact elements for making electric contact;
contacting the components via the contact elements in order to generate a current path; and
generating a flow of current in the current path in order to bond the contact elements via the thermal energy produced in the current path.

A flow of current is advantageously generated in the current path in such a way that the contact elements bond at the contact points via the heat or thermal energy produced in the current path. The aforementioned “contacting of the components” is thus to be understood in particular as a pre-positioning or pre-contacting of the components. This contacting is to be performed such that the components are sufficiently connected so as to be able to form a current path or a flow of current. By introducing energy into the current path, to generate the flow of current, the pre-positioned or pre-contacted contact points are automatically bonded. Here, use is made of the fact that the contact resistances occurring at the contact points lead to losses which result in a development of heat, wherein this heat is advantageously used to generate the bonds.

Appropriate means are preferably provided at the contact points and allow or assist the formation of a bond. Solder material is typically held ready for example at the contact points.

The energy can be introduced from outside or via a component that is a (constituent) part of the electric system. For example, a resistor is used for open-loop/closed-loop control of the flow of current.

According to a preferred embodiment at least one component is an energy storage unit, in particular an electric energy store. The method preferably comprises, correspondingly, the steps of:
introducing a (load) resistance, in particular an electronic load, into the current path;
using the electric energy store to generate the flow of current.

The electronic load is a device or an assembly that can be used as a replacement for a conventional load resistor. The flow of current within the current path can be set to a desired measure via the resistor or the electronic load.

In the present case the energy storage unit or the electric energy store, which is itself a constituent part of the electric system, is advantageously used to contact the electric system. The energy for soldering is advantageously applied by the electric energy store itself.

Alternatively the energy can also be introduced into the current path via an external energy source, which is thus not a constituent part of the electric system to be contacted. In this case too, one of the main advantages of the method remains, that specifically the individual contact points do not have to be contacted in a bonded manner or soldered sequentially, but directly concurrently in one method step.

According to embodiments the energy store is charged as the energy is introduced via an external energy source.

According to a particularly preferred embodiment the method comprises the steps of:
providing a plurality of battery modules;
contacting the battery modules via power cables to form a high-voltage store, wherein the high-voltage store forms a current path;
generating a flow of current in the current path by means of the high-voltage store in such a way that the power cables are soldered at the contact points.

The components are thus, in the present case, in particular battery modules and power cables or module connectors, which are intended for connecting or contacting the battery modules. The module connectors or power cables are typically copper cables or metal and/or copper tracks. In the present case these advantageously can be sized much smaller, since the contact resistances at the contact points are smaller on account of the bonding. This results in savings in respect of installation space, weight and cost.

According to an embodiment the method comprises the step of:
contacting the contact elements in a form-fitting and/or frictionally engaged manner.

The contacting in a form-fitting and/or frictionally engaged manner is expediently designed in such a way that the contact elements are sufficiently contacted in order for a current path to be formed.

According to an embodiment the method comprises the step of:
applying a clamping force via a clamping device for contacting at least two contact elements.

For example, two contact elements, that is to say one contact point, are contacted relative to one another via a clamping device of this kind, in particular are contacted temporarily. The clamping device is expediently removed subsequently to or after the generation of the bond. The clamping device is advantageously formed in such a way that a plurality of contact points can be contacted or pre-contacted, whereby the effort involved can be significantly reduced.

According to an embodiment the method comprises the step of:
applying a prestress, in particular by shaping, to at least one contact element to make contact in a frictionally engaged manner.

Suitably formed components, where possible, are expediently shaped at least in regions, for example in order to induce a (pre)stress, which can be used to allow frictionally engaged contacting between two contact elements or components. An approach of this kind is then expedient for example if the components are conductors in the form of tabs or the like.

According to an embodiment the method comprises the step of:
providing solder material at the contact elements.

As already mentioned, solder material in particular is used for bonding. In particular the bonding is thus to be understood to be a soldering method. The melting point of the solder material typically lies between 180° C. and 260° C. To reach these temperatures at the contact points, the flow of current in the current path is temporarily adjusted accordingly. The bonding is performed expediently above the thermal durability of the components, in particular of the module connectors or power cables.

According to an embodiment the method comprises the step of:
contacting the components in a bonded manner, in particular by means of adhesive.

According to an embodiment adhesive is held ready at the contact points in order to pre-contact or pre-position the contact elements.

According to an embodiment the method comprises the step of:
embedding the solder material into the adhesive.

According to an embodiment a corresponding material mixture can be applied to at least one of the components or one of the contact elements.

According to an embodiment at least one contact element comprises a solder pocket or forms a solder pocket. The solder pocket is expediently formed to provide a solder deposit, that is to say a specific amount of solder material, which is required for the subsequent connection. Here, the solder pocket can also be formed in such a way that a congruently formed contact element can be arranged, or in particular plugged in, in a form-fitting and/or frictionally engaged manner for pre-contacting. The solder pocket is formed in accordance with an embodiment as a recess, return, opening or bore, etc., in the particular component or in the particular contact element. The components are expediently, inter alia, power cables, wherein the power cable ends are formed with solder pockets.

Further alternatively, fasteners such as screws can also be used for form-fitting and/or frictionally engaged pre-contacting and remain at the contact point or can also be removed again.

According to an embodiment the method comprises the step of:
adjusting, in particular increasing, the contact resistance at a contact point of at least two contact elements, in particular by introducing an appropriate material into or at the contact point.

The aforementioned material is expediently selected to modify, in particular to increase, the contact resistance such that a development of heat is achieved selectively in order to form the bond. Alternatively, the contact resistance can be achieved selectively by a local/regional material retraction, for example a cross-section reduction of a conductor. According to an embodiment, air pockets are provided selectively, which can then be filled by the solder material.

According to an embodiment the aforementioned adhesive can be formed as a material via which the contact resistance is increased.

Typical (nominal) currents for achieving the bond(s) lie, for example, in a range of from 1200 to 1600 A, with (nominal) voltages in a range of from 300V to 500V. The nominal currents of high-voltage batteries for hybrid vehicles may also be much lower. The nominal voltages, particularly in the future, may also be much higher, for example in a range of from 800V to 1000V.

According to a preferred embodiment, the method for establishing contact in a bonded manner is carried out directly after the production or manufacture of the electric system, for example of the high-voltage store. The soldering process thus advantageously takes place directly after the end of production.

The invention also relates to an energy storage unit, in particular a high-voltage store, which is contacted or produced by the method according to the invention. High-voltage stores of this kind preferably comprise a plurality of battery modules which are assembled to form the high-voltage store. The battery modules expediently each comprise a plurality of energy storage cells, in particular accumulators. Preferred kinds or types of energy storage cells are, for example, lithium ion, lithium sulphur, or iron phosphate cells. Typical housing designs of the energy storage cells are round cells and in particular prismatic cells, in particular thus housings with fixed bodies. In addition, however, energy storage cells with soft housings, also known as pouch cells, can also be used. Energy storage cells can also be capacitors or supercapacitors. Energy storage units of the kind in question are used in particular as energy stores in partly and/or fully electrically driven motor vehicles. They are also called traction or drive batteries.

The invention also relates to the use of the energy of an energy storage unit, in particular an electric energy storage unit such as a high-voltage store, in a current path for bonding contact points in the current path. The energy necessary for the bond, preferably for soldering, is thus expediently applied by the energy storage unit itself. It has proven to be advantageous that, for example, power cables with solder pockets arranged at an end are used, wherein the solder pockets can be used on the one hand for pre-positioning or pre-contacting the power cables, and also for providing the solder material necessary for the soldering.

According to an embodiment the energy of the energy storage unit is used for resoldering. This means that, during operation of the energy storage unit, maintenance soldering may expediently be performed as necessary. The currents occurring during operation are used for resoldering or the energy storage unit is temporarily operated in such a way that a resoldering can take place at the contact points. This is particularly advantageous since an optimal connection at the contact points can thus be ensured over the service life of the energy storage unit, or generally the electric system.

Further advantages and features can be found in the following description of embodiments of various components or methods with reference to the appended figures.

### BRIEF DESCRIPTION OF THE DRAWINGS

FIG. 1 shows a plurality of contact elements which form contact points, contacted via a clamping device;

FIG. 2 shows a further embodiment of a contact point;

FIG. 3 shows two embodiments of components together with contact elements; and

FIG. 4 shows a further embodiment of a contact point.

### DETAILED DESCRIPTION

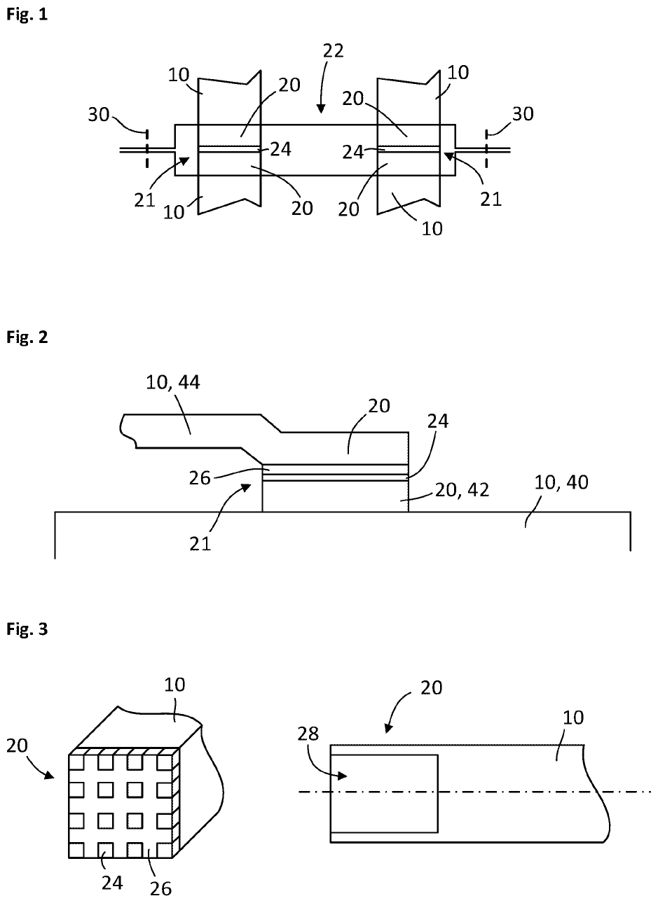

FIG. 1 shows a schematic view of a clamping device 22, which comprises two tabs which are connected via fastener 30, sketched in the present case as dashed lines. The fastener 30 can include screw connections. Two components 10 can be seen in each case, which have contact elements 20 at an end. Solder material 24 is arranged on one of the contact elements 20 in each case. The corresponding contact elements 20 are compressed by the clamping device 22, wherein the solder material 24 is arranged in between. If a sufficiently high current now flows via the components 10 or contact elements 20, soldering occurs automatically at the contact elements 21. The clamping device 22 can then be removed.

FIG. 2 shows a further schematically illustrated embodiment of a contact point 21 in a schematic depiction, wherein one component 10 in the present case is formed for example as a power cable or module connector 44, which at the end has a contact element 20, on which there is arranged an insulation material 26. The insulation material preferably serves to increase the contact resistance, or in particular to increase the contact resistance selectively and in some regions, in order to generate heat additionally. The insulation material 26 can act simultaneously as adhesive. A further component 10 is sketched in the present case as an electric energy store or battery module which comprises a voltage tap 42, which in the present case represents a second contact element 20. Solder material 24 is provided on this. It is schematically indicated that the power cable 44 is deformed. As a result of this deformation a voltage can be introduced into this component and can be used in order for the two contact elements 20 to be contacted with one another, in particular contacted in a frictionally engaged manner, so that a current path is formed.

FIG. 3 shows two schematically illustrated embodiments of components 10, wherein a component 10 is sketched in the left image half, for example as a conductor element, which at an end has a contact element 20, wherein this comprises an adhesive 26, in which there is embedded solder material 24. A component 10 is illustrated schematically in the right image half, for example a conductor element, which at an end has a contact element 20, which comprises a solder pocket 28. Solder material for the later soldering can be held ready or arranged in a solder pocket 28 of this kind. In addition, a solder pocket of this kind can be used to arrange a congruently formed (not shown here) contact element in a form-fitting and/or frictionally engaged manner for pre-positioning or pre-contacting.

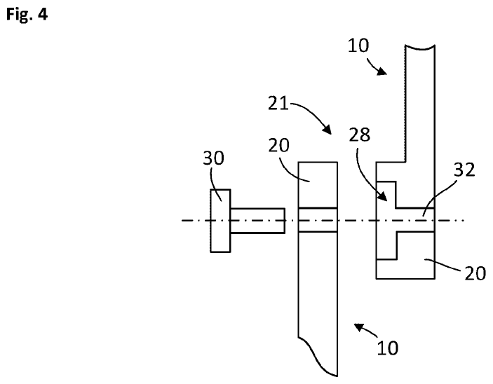

FIG. 4 shows a further schematically illustrated embodiment of a contact point 21, wherein two components 10, which at an end have contact elements 20, can rest against one another at the contact point 21. The right contact element 20 comprises a solder pocket 28 and an engagement region 32, which is designed to cooperate with a fastener 30. The two components 20 are pre-contacted relative to one another via the fastener 30. The actual bond is achieved indirectly via the solder, which is held ready in the solder pocket 28.

### LIST OF REFERENCE SIGNS

10 component
20 contact element
21 contact point
22 clamping device
24 solder material
26 adhesive, insulation material
28 solder pocket
30 fastener
32 engagement region
40 electric energy store, battery module
42 voltage tap
44 power cable, module connector

1-13. (canceled)

14. A method for contacting components in electric systems in a bonded manner,
comprising:
providing a plurality of components, wherein the plurality of components comprise contact elements configured for making electric contact;
contacting the plurality of components via the contact elements to generate a current path; and
generating a flow of current in the current path to bond the contact elements via the thermal energy produced in the current path.

15. The method according to claim 14,
wherein at least one component is an electric energy store, the method further comprising:
introducing a resistance into the current path and using the electric energy store to generate the flow of current.

16. The method according to claim 14, further comprising:
providing a plurality of battery modules;
contacting the plurality of battery modules via power cables to form a high-voltage store, wherein the high-voltage store forms the current path;
generating the flow of current in the current path by the high-voltage store in such a way that the power cables are soldered.

17. The method according to claim 14, further comprising:
contacting the contact elements in a form-fitting and/or frictionally engaged manner.

18. The method according to claim 17, further comprising:
applying a clamping force via a clamping device for contacting at least two contact elements.

19. The method according to claim 14, further comprising:
applying a prestress to at least one contact element by shaping the at least one contact element to make contact in a frictionally engaged manner.

20. The method according to claim 14, further comprising:
providing solder material at the contact elements.

21. The method according to claim 14, further comprising:
contacting the plurality of components in a bonded manner by an adhesive.

22. The method according to claim 21, further comprising:
embedding a solder material into the adhesive.

23. The method according to claim 14, further comprising:
increasing a contact resistance at a contact point of at least two contact elements by introducing an material that increases the contact resistance into or at the contact point.

24. The method according to claim 14, further comprising:
using energy of an energy storage unit in the current path to bond contact points of the contact elements in the current path.

25. The method according to claim 14, further comprising:
using energy of an energy storage unit in the current path to resolder contact points of the contact elements in the current path.

26. An energy storage unit produced by the method according to claim 14.
